(19) United States
(12) Patent Application Publication
(10) Pub. No.: US 2026/0341228 A1
(43) Pub. Date: Oct. 29, 2026

(54) Mode Selection Circuit and Display Device Including the Same

(71) Applicant: LG Display Co., Ltd., Seoul (KR)

(72) Inventor: Dae Seok Oh, Paju-si (KR)

(21) Appl. No.: 19/557,427

(22) Filed: Mar. 5, 2026

(30) Foreign Application Priority Data
Apr. 29, 2025 (KR) 10-2025-0056100

(51) Int. Cl. G09G 3/3266; G09G 3/3291

(52) U.S. Cl. CPC G09G 3/3266; G09G 3/3291; G09G 2320/028; G09G 2320/068; G09G 2330/021

(57) ABSTRACT

A display device includes a display panel including data lines, gate lines, and sub-pixels; a data driver including an output amplifier that supplies a data voltage of pixel data to the data lines; and a gate driver that supplies a gate signal to the gate lines. Each sub-pixel includes a first sub-pixel including a first light-emitting element that emits light at a first viewing angle in a first mode and a first driving element that drives the first light-emitting element, and a second sub-pixel including a second light-emitting element that emits light at a second viewing angle smaller than the first viewing angle in a second mode and a second driving element that drives the second light-emitting element. The first light-emitting element emits light in a first half frame period of one frame period, and the second light-emitting element emits light in a second half frame period of the one frame period.

### CROSS-REFERENCE TO RELATED APPLICATION

This application claims priority to and the benefit of Republic of Korea Patent Application No. 10-2025-0056100, filed Apr. 29, 2025, the disclosure of which is incorporated herein by reference in its entirety.

### BACKGROUND

### Field

The present disclosure relates to a mode selection circuit and a display device including the same.

### Discussion of Related Art

Variable viewing angle technology is being applied to display devices. Variable viewing angle technology may present video content or visual information reproduced on a display device only to a user within a narrow viewing angle range, or to multiple users within a wide viewing angle range.

As the market for future vehicles such as electric vehicles and self-driving cars expands, demand for vehicle display devices is rapidly increasing. Research is being conducted on a method of dividing the screen of a vehicle display device and controlling one part of the screen to have a narrow viewing angle and the other part to have a wide viewing angle. This technology may drive pixels with a narrow viewing angle arranged in one area of the screen to display personal contents or information that only a specific user may view, and simultaneously drive pixels with a wide viewing angle arranged in the other area of the screen to display shared contents that multiple users may view together.

In vehicle display devices, display panels for organic light emitting display devices are attracting attention. An organic light emitting display device includes an organic light emitting diode (hereinafter, referred to as “OLED”) that emits light by itself, and has an advantage in that the response speed is fast, the luminous efficiency and luminance are good, and the viewing angle is wide. The organic light emitting display device has a fast response speed, is excellent in terms of luminous efficiency, luminance and viewing angle, and provides an excellent contrast ratio and color reproducibility since it may express the black grayscale in complete black. Because the display panel of an organic light emitting display device may be flexibly bent, it may easily implement a curved surface. Due to these advantages, the share of organic light emitting display devices in the vehicle display device market is rapidly increasing.

### SUMMARY

In a display device to which a variable viewing angle technique is applied, an entire screen may be controlled at a certain viewing angle or a viewing angle may be controlled in units of a screen area having a preset size. There is a need for various measures capable of freely adjusting a screen area for viewing angle control.

The present disclosure is directed to solving all the above-described necessity and problems.

The present disclosure provides a mode selection circuit and a display device including the same.

It should be noted that objects of the present disclosure are not limited to the above-described objects, and other objects of the present disclosure will be apparent to those skilled in the art from the following descriptions.

A display device according to embodiments of the present disclosure may include a display panel in which a plurality of data lines, a plurality of gate lines, and a plurality of sub-pixels are disposed; a data driver including an output amplifier configured to supply a data voltage of pixel data to the data lines; and a gate driver configured to supply a gate signal to the gate lines, wherein each of the plurality of sub-pixels includes a first sub-pixel including a first light-emitting element that emits light at a first viewing angle in a first mode and a first driving element that drives the first light-emitting element, and a second sub-pixel including a second light-emitting element that emits light at a second viewing angle smaller than the first viewing angle in a second mode and a second driving element that drives the second light-emitting element, and the first light-emitting element emits light in a first half frame period of one frame period, and the second light-emitting element emits light in a second half frame period of the one frame period.

A mode selection circuit according to embodiments of the present disclosure may include a first switch part connected to an output end of an output amplifier in a data driver, and configured to transmit or block a data voltage that is output from the output end, in response to an enable signal; a second switch part configured to selectively output the transmitted data voltage or a predetermined ground voltage in response to the enable signal; and a third switch part configured to supply the output data voltage or ground voltage to each of a plurality of sub-pixels in response to a MUX signal, wherein each of the plurality of sub-pixels includes a first sub-pixel including a first light-emitting element that emits light at a first viewing angle in a first mode and a first driving element that drives the first light-emitting element and a second sub-pixel including a second light-emitting element that emits light at a second viewing angle smaller than the first viewing angle in a second mode and a second driving element that drives the second light-emitting element, and the first light-emitting element emits light in a first half frame period of one frame period, and the second light-emitting element emits light in a second half frame period of the one frame period.

According to the embodiments of the present disclosure, one sub-pixel includes the first sub-pixel that is driven in the first mode and the second sub-pixel that is driven in the second mode, and interlace driving is performed such that the first data voltage according to the first mode is supplied to the first sub-pixel and the second data voltage or the ground voltage according to the second mode is supplied to the second sub-pixel. With this, it is possible to freely change a shape or a position of an area that is driven in the second mode.

According to the embodiments of the present disclosure, it is possible to achieve reduction in power consumption through interlace driving of the first sub-pixel and the second sub-pixel composing one sub-pixel, and as a result, to perform low power driving.

The effects of the present specification are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram showing a display device according to an embodiment of the present disclosure;

FIG. 2 is a circuit diagram showing a pixel circuit according to the embodiment of the present disclosure;

FIG. 3 is a diagram showing a driving timing of the pixel circuit shown in FIG. 2;

FIGS. 4 to 7 are diagrams illustrating a mode switching principle according to the embodiment of the present disclosure;

FIG. 8 is a diagram showing a mode selector according to a first embodiment of the present disclosure;

FIGS. 9 to 12 are diagrams illustrating an operation of the mode selector shown in FIG. 8;

FIG. 13 is a diagram showing a mode selector according to a second embodiment of the present disclosure;

FIGS. 14 to 17 are diagrams illustrating an operation of a MUX switch part shown in FIG. 13;

FIG. 18 is a diagram showing an implementation example of a first scan driver shown in FIG. 13.

### DETAILED DESCRIPTION OF EXEMPLARY EMBODIMENTS

Advantages and features of the present specification and methods of achieving them will become apparent with reference to preferable embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor (PMOS), since carriers are holes, a source voltage is higher than a drain voltage such that holes may flow from a source to a drain. In the p-channel transistor, since holes flow from the source to the drain, a current flows from the source to the drain. It should be noted that a source and a drain of a transistor are not fixed. For example, a source and a drain may be changed according to an applied voltage. Therefore, the disclosure is not limited due to a source and a drain of a transistor. In the following description, a source and a drain of a transistor will be referred to as a first electrode and a second electrode.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

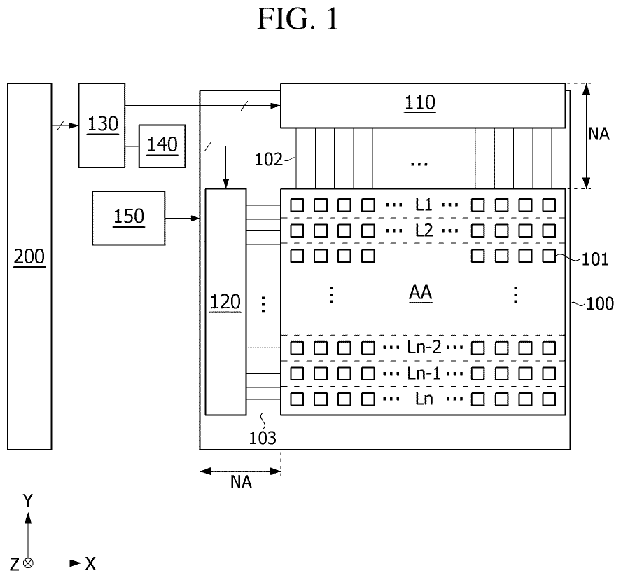

FIG. 1 is a block diagram showing a display device according to an embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels 101 arranged in a matrix form. The display panel 100 may further include power lines commonly connected to the pixels. The power lines may be commonly connected to pixel circuits to supply a voltage required for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The pixels may be arranged as real color pixels and pentile pixels. A pentile pixel may realize a higher resolution than a real color pixel by driving two sub-pixels with different colors as one pixel 101 and using a preset pixel rendering algorithm. This pixel rendering algorithm may compensate for insufficient color representation in each pixel with the color of light emitted from adjacent pixels.

Each of the pixels may include at least one first light-emitting element that emits light in first mode (S-Mode/SMODE), and a second light-emitting element that emits light in second mode (P-Mode/PMODE). Each of the pixels 101 emits light from the first light-emitting element at a narrow viewing angle in first mode, while emitting light from the second light-emitting element at a wide viewing angle in second mode.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 200 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 may be disposed in the non-display areas NA on both sides of the display panel 100 with the display area AA of the display panel interposed therebetween to supply gate pulses on both sides of the gate lines 103 in a double feeding method. In another embodiment, the gate driver 120 may be disposed in at least one of the left and right non-display areas NA of the display panel 100 to supply gate signals to the gate lines 103 in a single feeding method. The gate driver 120 sequentially outputs pulses of the gate signals to the gate lines 103 under the control of the timing controller 130. The gate driver 120 may sequentially supply the gate signals to the gate lines 103 by shifting the pulses of the gate signals using shift registers. When a plurality of gate signals are applied to each pixel, the gate driver 120 may include a plurality of shift registers. The gate signal may include a scan signal being input to the pixel circuit through a plurality of gate lines, and an emission signal (or EM signal).

The timing controller 130 receives digital video data of an input image and a timing signal synchronized with this data from the host system 200. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 200. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The host system 200 may include a main board of one of a television system, a set-top box, a navigation system, a personal computer (PC), a vehicle system, a mobile terminal, and a wearable terminal. The host system 200 may scale an image signal from a video source according to the resolution of the display panel 100, and may transmit it to the timing controller 130 together with the timing signals.

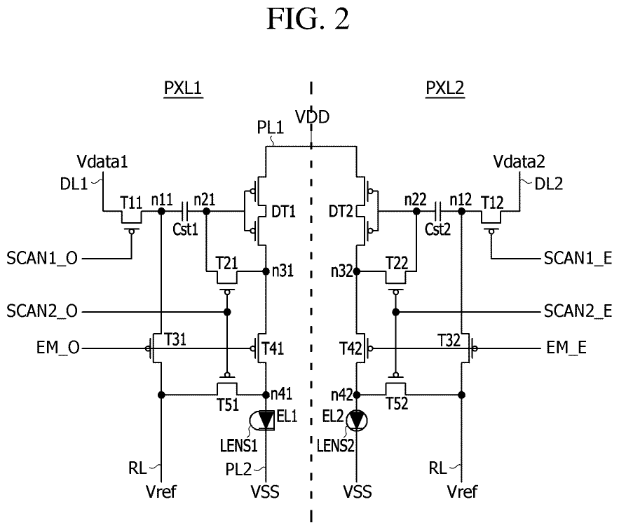

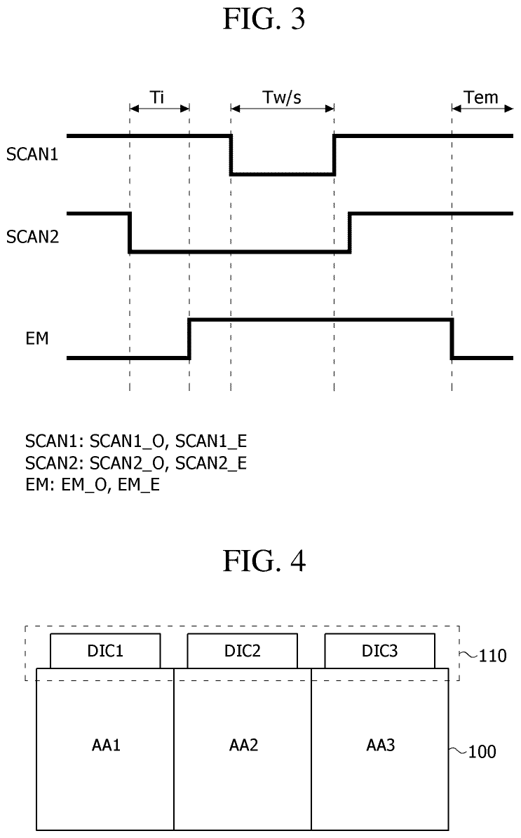

FIG. 2 is a circuit diagram showing a pixel circuit according to the embodiment of the present disclosure. FIG. 3 is a diagram showing a driving timing of the pixel circuit shown in FIG. 2.

Referring to FIG. 2, the pixel circuit according to the present disclosure includes a first pixel circuit PXL1 that is driven in a first mode SMODE and a second pixel circuit PXL2 that is driven in a second mode PMODE.

The first pixel circuit PXL1 and the second pixel circuit PXL2 include light-emitting elements EL1 and EL2, driving elements DT1 and DT2 that drive the light-emitting elements EL1 and EL2, a plurality of switch elements T11 to T51 and T12 to T52, and capacitors Cst1 and Cst2, respectively. Each of the driving elements DT1 and DT2 and the plurality of switch elements T11 to T51 and T12 to T52 may be implemented as a p-channel transistor, but embodiments of the present disclosure are not limited thereto.

The pixel circuit is connected to power lines to which direct-current voltages or constant voltages are applied, such as a pixel driving voltage line or a first power line PL1 to which a pixel driving voltage VDD is applied, a pixel ground voltage line or a second power line PL2 to which a pixel ground voltage VSS is applied, and a reference voltage line RL to which a reference voltage Vref is applied. The power lines may be connected in common to all pixels on the display panel 100.

Each of the first and second light-emitting elements EL1 and EL2 may be implemented as an OLED. Each of the first and second light-emitting elements EL1 and EL2 includes an anode electrode, a cathode electrode, and an organic compound layer formed between these electrodes. The anode electrode of the first light-emitting element EL1 is connected to a forty-first node n41, and the cathode electrode of the first light-emitting element EL1 is connected to the second power line PL2 to which the pixel ground voltage VSS is applied. The anode electrode of the second light-emitting element EL2 is connected to a forty-second node n42, and the cathode electrode of the second light-emitting element EL2 is connected to the second power line PL2 to which the pixel ground voltage VSS is applied. The organic compound layer may include a hole Injection layer (HIL), a hole transport layer (HTL), a light emission layer (EML), an electron transport layer (ETL), and an electron Injection layer (EIL), but embodiments of the present disclosure are not limited thereto. The light-emitting element EL (the first light-emitting element EL1 and the second light-emitting element EL2 may be collectively referred to as a light-emitting element EL) may be implemented as a tandem structure in which a plurality of light emission layers are stacked. The light-emitting element EL having the tandem structure can improve the luminance and lifetime of the pixels.

The first driving element DT1 generates a current according to a gate-source voltage Vgs to drive the first light-emitting element EL1. The first driving element DT1 includes a first electrode connected to the first power line PL1 to which the pixel driving voltage VDD is applied, a gate electrode connected to a twenty-first node n21, and a second electrode connected to a thirty-first node n31.

The first driving element DT1 may have a dual gate structure such that current leakage is minimized.

An eleventh switch element T11 is connected between a first data line DL1 to which a first data voltage Vdata1 is applied and an eleventh node n11. The eleventh switch element T11 is turned on in response to a gate on voltage VGL of a first gate signal SCAN1 and connects the first data line DL1 to the eleventh node n11. The eleventh switch element T11 includes a first electrode connected to the first data line DL1, a gate electrode to which the first gate signal SCAN1 is applied, and a second electrode connected to the eleventh node n11.

A twenty-first switch element T21 is connected between a twenty-first node n21 and a thirty-first node n31. The twenty-first switch element T21 is turned on in response to a gate on voltage VGL of a second gate signal SCAN2 and connects the twenty-first node n21 and the thirty-first node n31. The twenty-first switch element T21 includes a first electrode connected to the twenty-first node n21, a gate electrode to which the second gate signal SCAN2 is applied, and a second electrode connected to the thirty-first node n31.

A thirty-first switch element T31 is connected between an eleventh node n11 and a reference voltage line RL. The thirty-first switch element T31 is turned on in response to a gate on voltage VGL of a third gate signal EM and connects the reference voltage line RL to the eleventh node n11. The thirty-first switch element T31 includes a first electrode connected to the eleventh node n11, a gate electrode to which the third gate signal EM is applied, and a second electrode connected to the reference voltage line RL.

A forty-first switch element T41 is connected between the thirty-first node n31 and the forty-first node n41. The forty-first switch element T41 is turned on in response to the gate on voltage VGL of the third gate signal EM and connects the thirty-first node n31 and the forty-first node n41. The forty-first switch element T41 includes a first electrode connected to the thirty-first node n31, a gate electrode to which the third gate signal EM is applied, and a second electrode connected to the forty-first node n41.

A fifty-first switch element T51 is connected between the forty-first node n41 and the reference voltage line RL. The fifty-first switch element T51 is turned on in response to the gate on voltage VGL of the second gate signal SCAN2 and connects the reference voltage line RL to the forty-first node n41. The fifty-first switch element T51 includes a first electrode connected to the reference voltage line RL, a gate electrode to which the second gate signal SCAN2 is applied, and a second electrode connected to the forty-first node n41.

The second driving element DT2 generates a current according to a gate-source voltage Vgs to drive the second light-emitting element EL2. The second driving element DT2 includes a first electrode connected to the first power line PL1 to which the pixel driving voltage VDD is applied, a gate electrode connected to a twenty-second node n22, and a second electrode connected to a thirty-second node n32.

The second driving element DT2 may have a dual gate structure to minimize current leakage.

A twelfth switch element T12 is connected between a second data line DL2 to which a second data voltage Vdata2 is applied and a twelfth node n12. The twelfth switch element T12 is turned on in response to the gate on voltage VGL of the first gate signal SCAN1 and connects the second data line DL2 to the twelfth node n12. The twelfth switch element T12 includes a first electrode connected to the second data line DL2, a gate electrode to which the first gate signal SCAN1 is applied, and a second electrode connected to the twelfth node n12.

A twenty-second switch element T22 is connected between the twenty-second node n22 and the thirty-second node n32. The twenty-second switch element T22 is turned on in response to the gate on voltage VGL of the second gate signal SCAN2 and connects the twenty-second node n22 and the thirty-second node n32. The twenty-second switch element T22 includes a first electrode connected to the twenty-second node n22, a gate electrode to which the second gate signal SCAN2 is applied, and a second electrode connected to the thirty-second node n32.

A thirty-second switch element T32 is connected between the twelfth node n12 and the reference voltage line RL. The thirty-second switch element T32 is turned on in response to the gate on voltage VGL of the third gate signal EM and connects the reference voltage line RL to the twelfth node n12. The thirty-second switch element T32 includes a first electrode connected to the twelfth node n12, a gate electrode to which the third gate signal EM is applied, and a second electrode connected to the reference voltage line RL.

A forty-second switch element T42 is connected between the thirty-second node n32 and the forty-second node n42. The forty-second switch element T42 is turned on in response to the gate on voltage VGL of the third gate signal EM and connects the thirty-second node n32 and the forty-second node n42. The forty-second switch element T42 includes a first electrode connected to the thirty-second node n32, a gate electrode to which the third gate signal EM is applied, and a second electrode connected to the forty-second node n42.

A fifty-second switch element T52 is connected between the forty-second node n42 and the reference voltage line RL. The fifty-second switch element T52 is turned on in response to the gate on voltage VGL of the second gate signal SCAN2 and connects the reference voltage line RL to the forty-second node n42. The fifty-second switch element T52 includes a first electrode connected to the reference voltage line RL, a gate electrode to which the second gate signal SCAN2 is applied, and a second electrode connected to the forty-second node n42.

A first lens LENS1 may be disposed on the first light-emitting element EL1. The first lens LENS1 may be a semi-cylindrical lens in order to limit a vertical viewing angle (sometimes also referred to as an up-down viewing angle) and widen a horizontal viewing angle (sometimes also referred to as a left-right viewing angle). The first lens LENS1 is long in a horizontal direction (or the X-axis direction) of the display panel 100 and narrow in a vertical direction thereof. The first lens LENS1 may have a hemispherical cross section. The first lens condenses light traveling in the vertical direction among light of the first light-emitting element EL1 emitted in the first mode SMODE to narrow the vertical viewing angle and widen the horizontal viewing angle. The shape of the first lens LENS 1 is not limited thereto, and may be any other shape as long as the vertical viewing angle can be limited and the horizontal viewing angle can be widened.

A second lens LENS2 may be disposed on the second light-emitting element EL2. The second lens LENS2 may be a semi-spherical lens whose thickness is larger at the center and smaller toward an edge thereof. The second lens LENS2 may condense light of the second light-emitting element EL2 emitted in the second mode PMODE to narrow up-down and left-right viewing angles of the second light-emitting element EL2. The shape of the second lens LENS 2 is not limited thereto, and may be any other shape as long as the vertical and left-right viewing angles of the second light emitting element EL 2 can be narrowed.

By the first lens LENS1, the vertical viewing angle of the first light-emitting element EL1 is comparable to that of the second light-emitting element EL2, and the horizontal viewing angle thereof is larger than that of the second light-emitting element EL2.

Light emitted from a screen of a vehicle display disposed on a dashboard of a vehicle may travel to a front-facing camera disposed in front of an upper end of a room in the vehicle, and the screen of the vehicle display may be seen in an image captured by the front-facing camera. The first lens LENS1 limits the vertical viewing angle of the first light-emitting element EL1 that emits light in the first mode SMODE to prevent a ghost image of the screen of the vehicle display, which is captured by the front-facing camera.

The first and second lenses LENS1 and LENS2 may be implemented as transparent media or transparent insulating layer patterns disposed in the display panel 100, but the present disclosure is not limited thereto.

The first light-emitting element EL1 emits light at a first viewing angle by the first lens LENS1, and the second light-emitting element EL2 emits light at a second viewing angle smaller than the first viewing angle by the second lens LENS2.

This pixel circuit may be driven in a first mode in which the first light-emitting device EL1 with a wide viewing angle emits light, or in a second mode in which the second light-emitting device EL2 in a narrow viewing angle emits light.

The first and second pixel circuits according to the embodiments are driven in an order of an initialization period Ti, a data writing and sensing period Tw/s, and an emission period Tem in the first mode and the second mode as in FIG. 3. A time at which the initialization period Ti, the data writing and sensing period Tw/s, and the emission period Tem are performed may be controlled by the waveforms of the gate signals SCAN1, SCAN2, and EM.

FIGS. 4 to 7 are diagrams illustrating a mode switching principle according to the embodiment of the present disclosure.

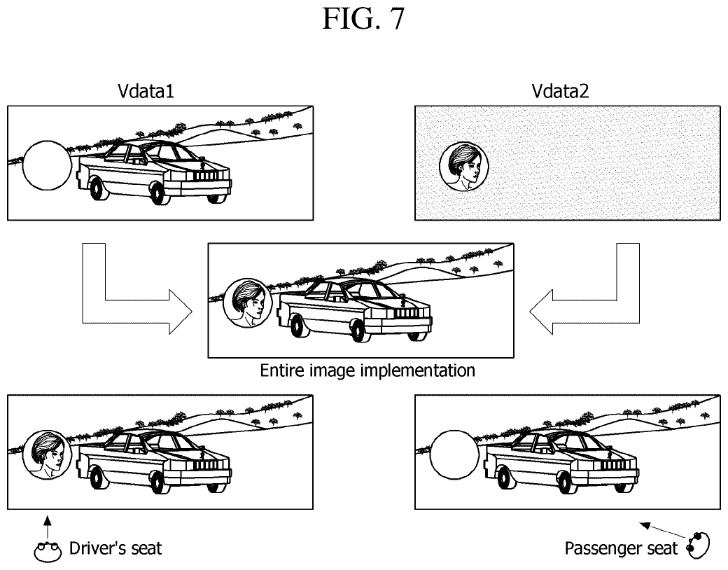

Referring to FIGS. 4 and 7, the display device according to the embodiment of the present disclosure may include one or more source drive ICs DIC1, DIC2, and DIC3. The display area AA of the display panel 100 may be divided into one or more display areas AA1, AA2, and AA3.

For example, as in FIG. 4, a data voltage of pixel data that is output from a first source drive IC DIC1 may be supplied to a first display area AA1 of the display panel. A data voltage of pixel data that is output from a second source drive IC DIC2 may be supplied to a second display area AA2 of the display panel. A data voltage of pixel data that is output from a third source drive IC DIC3 may be supplied to a third display area AA3 of the display panel.

A pixel according to the embodiments includes a red sub-pixel, a green sub-pixel, and a blue sub-pixel, and the sub-pixel for each color may include a first sub-pixel S-PXL that emits light in the first mode and a second sub-pixel P-PXL that emits light in the second mode.

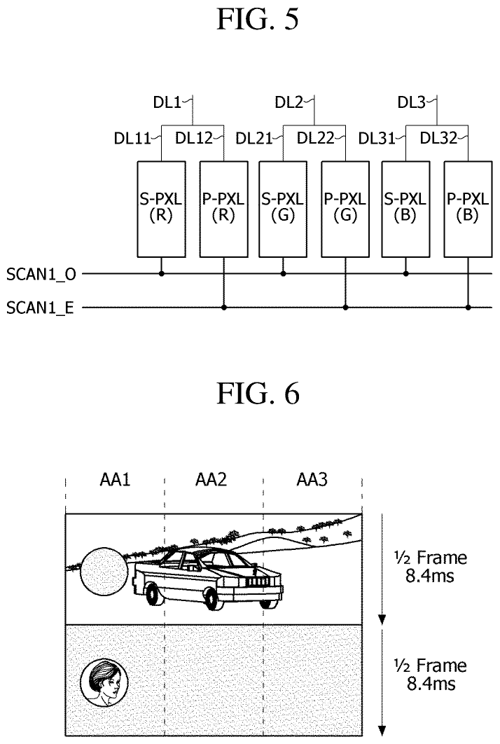

For example, as in FIG. 5, the red sub-pixel may include a first red sub-pixel S-PXL(R) and a second red sub-pixel P-PXL(R), the green sub-pixel may include a first green sub-pixel S-PXL(G) and a second green sub-pixel P-PXL(G), and the blue sub-pixel may include a first blue sub-pixel S-PXL(B) and a second blue sub-pixel P-PXL(B). The first red sub-pixel S-PXL(R), the first green sub-pixel S-PXL(G), and the first blue sub-pixel S-PXL(B) may be pixels that are driven in the first mode, and the second red sub-pixel P-PXL(R), the second green sub-pixel P-PXL(G), and the second blue sub-pixel P-PXL(B) may be pixels that are driven in the second mode.

A first scan signal SCAN1_O may be applied to the first red sub-pixel S-PXL(R), the first green sub-pixel S-PXL(G), and the first blue sub-pixel S-PXL(B), and a first scan signal SCAN1_E may be applied to the second red sub-pixel P-PXL(R), the second green sub-pixel P-PXL(G), and the second blue sub-pixel P-PXL(B). Data lines DL1, DL2, and DL3 may be connected to data lines DL11, DL21, and DL31 of the first red sub-pixel S-PXL(R), the first green sub-pixel S-PXL(G), respectively, and the first blue sub-pixel S-PXL(B) by the first scan signal SCAN1_O, and the data lines DL1, DL2, and DL3 may be connected to data lines DL12, DL22, and DL32 of the second red sub-pixel P-PXL(R), the second green sub-pixel P-PXL(G), and the second blue sub-pixel P-PXL(B) by the first scan signal SCAN1_E.

In the embodiment, by making one sub-pixel include the first sub-pixel that is driven in the first mode and the second sub-pixel that is driven in the second mode, it is possible to freely change a shape of a position of an area that is driven in the second mode.

To this end, in the embodiment, as in FIG. 6, one frame period may be divided into a first half frame period and a second half frame period, a data voltage of pixel data according to the first mode may be supplied to the first sub-pixel in the first half frame period, and a data voltage of pixel data according to the second mode may be supplied to the second sub-pixel in the second half frame period. For example, one frame period may be 16.8 milliseconds (ms), and the first half frame period and the second half frame period may be 8.4 ms, but embodiments of the present disclosure are not limited thereto.

As in FIG. 6, in the first half frame period, the data voltage according to the first mode may be supplied to the first sub-pixel in the first display area AA1, the second display area AA2, and the third display area AA3.

In the second half frame period, the data voltage and a ground voltage according to the second mode may be supplied to the second sub-pixel in the first display area AA1 of the first display area, the ground voltage may be supplied to the second sub-pixel in the second display area AA2, and the ground voltage may be supplied to the second sub-pixel in the third display area AA3. Only the ground voltage may be supplied in the second display area AA2 and the third display area AA3 without the data voltage.

As in FIG. 7, in one frame period, the entire image may be displayed through interlace driving of the first sub-pixel and the second sub-pixel. A partial image in the displayed entire image may be viewed only at a certain position (such as a location corresponding to a range where a particular person, such as a driver, is located).

For example, all display areas of a screen of a display for a vehicle m be viewed on a driver's seat, and some display areas of the screen of the display for a vehicle may be viewed on a passenger seat. That is, an image that is displayed according to the second mode is not viewed on the passenger seat. Alternatively, the image displayed in the second mode may be rendered invisible to the driver by appropriately configuring the screen's display regions (e.g., by setting the display region such that the second-mode image is outside the driver's viewing zone).

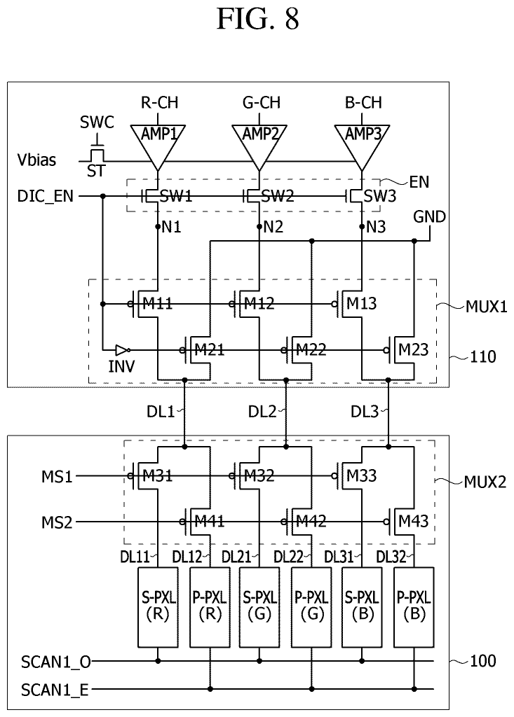

FIG. 8 is a diagram showing a mode selector according to a first embodiment of the present disclosure.

Referring to FIG. 8, a mode selector SEL according to a first embodiment of the present disclosure may perform control such that the data voltage according to the first mode or the second mode is supplied to the first sub-pixel or the second sub-pixel. The mode selector SEL may include a first switch part EN, a second switch part MUX1, a third switch part MUX2, and a driving switch ST. Herein, MUX stands for Multiplexer.

The first switch part EN may selectively transmit the data voltage in response to an enable signal DIC_EN. The first switch part EN may include a first switch SW1, a second switch SW2, and a third switch SW3. Each of the first switch SW1, the second switch SW2, and the third switch SW3 may be implemented as an n-channel TFT, but embodiments of the present disclosure are not limited thereto.

The first switch SW1 may transmit the data voltage in response to the enable signal DIC_EN. The first switch SW1 includes a gate electrode to which the enable signal DIC_EN is applied, a first electrode connected to an output end of a first output amplifier AMP1, and a second electrode connected to a first output node N1 (sometimes referred to as a channel node of the second switch part MUX1).

The second switch SW2 may transmit the data voltage in response to the enable signal DIC_EN. The second switch SW2 includes a gate electrode to which the enable signal DIC_EN is applied, a first electrode connected to an output end of a second output amplifier AMP2, and a second electrode connected to a second output node N2 (sometimes referred to as a channel node of the second switch part MUX1).

The third switch SW3 may transmit the data voltage in response to the enable signal DIC_EN. The third switch SW3 include a gate electrode to which the enable signal DIC_EN is applied, a first electrode connected to an output end of a third output amplifier AMP3, and a second electrode connected to a third output node N3 (sometimes referred to as a channel node of the second switch part MUX1).

The second switch part MUX1 may output one of the data voltage and the ground voltage in response to the enable signal DIC_EN. The second switch part MUX1 may include a first-first MUX switch M11, a first-second MUX switch M12, a first-third MUX switch M13, a second-first MUX switch M21, a second-second MUX switch M22, a second-third MUX switch M23, and an inverter INV. Each of the first-first MUX switch M11, the first-second MUX switch M12, the first-third MUX switch M13, the second-first MUX switch M21, the second-second MUX switch M22, and the second-third MUX switch M23 may be implemented as an n-channel TFT, but embodiments of the present disclosure are not limited thereto.

The first-first MUX switch M11 may be turned on in response to the enable signal DIC_EN and may connect the output end (alternatively connected to the first output node N1) of the first output amplifier AMP1 and the first data line DL1. The first-first MUX switch M11 includes a gate electrode to which the enable signal DIC_EN is applied, a first electrode connected to the output end (alternatively connected to the first output node N1) of the first output amplifier AMP1, and a second electrode connected to the first data line DL1.

The first-second MUX switch M12 may be turned on in response to the enable signal DIC_EN and may connect the output end (alternatively connected to the second output node N2) of the second output amplifier AMP2 and the second data line DL2. The first-second MUX switch M12 includes a gate electrode to which the enable signal DIC_EN is applied, a first electrode connected to the output end (alternatively connected to the second output node N2) of the second output amplifier AMP2, and a second electrode connected to the second data line DL2.

The first-third MUX switch M13 may be turned on in response to the enable signal DIC_EN and may connect the output end (alternatively connected to the third output node N3) of the third output amplifier AMP3 and the third data line DL3. The first-third MUX switch M13 includes a gate electrode to which the enable signal DIC_EN is applied, a first electrode connected to the output end (alternatively connected to the third output node N3) of the third output amplifier AMP3, and a second electrode connected to the third data line DL3. The first-first MUX switch M11, the first-second MUX switch M12, and the first-third MUX switch M13 may be collectively referred to as the first MUX switch M1.

The second-first MUX switch M21 may be turned on in response to an inverted enable signal DIC_EN and may connect the ground GND and the first data line DL1. The second-first MUX switch M21 includes a gate electrode to which the inverted enable signal DIC_EN is applied, a first electrode connected to the ground GND, and a second electrode connected to the first data line DL1.

The second-second MUX switch M22 may be turned on in response to the inverted enable signal DIC_EN and may connect the ground GND and the second data line DL2. The second-second MUX switch M22 includes a gate electrode to which the inverted enable signal DIC_EN is applied, a first electrode connected to the ground GND, and a second electrode connected to the second data line DL2.

The second-third MUX switch M23 may be turned on in response to the inverted enable signal DIC_EN and may connect the ground GND and the third data line DL3. The second-third MUX switch M23 includes a gate electrode to which the inverted enable signal DIC_EN is applied, a first electrode connected to the ground GND, and a second electrode connected to the third data line DL3.

The inverter INV may invert the enable signal DIC_EN and may apply the inverted enable signal DIC_EN to the second MUX switch M2. The second-first MUX switch M21, the second-second MUX switch M22, and the second-third MUX switch M23 may be collectively referred to as the second MUX switch M2.

The third switch part MUX2 may supply the data voltage or the ground voltage output from the second switch part MUX1 to the first sub-pixel or the second sub-pixel according to a MUX signal (i.e., a multiplex switching signal) MS1 or MS2. The third switch part MUX2 may include a third-first MUX switch M31, a fourth-first MUX switch M41, a third-second MUX switch M32, a fourth-second MUX switch M42, a third-third MUX switch M33, and a fourth-third MUX switch M43. Each of the third MUX switch M3 and the fourth MUX switch M4 may be implemented as a p-channel TFT, but embodiments of the present disclosure are not limited thereto.

The third-first MUX switch M31, the third-second MUX switch M32, and the third-third MUX switch M33 may be collectively referred to as a third MUX switch, and the fourth-first MUX switch M41, the fourth-second MUX switch M42, and the fourth-third MUX switch M43 may be collectively referred to as a fourth MUX switch.

The third-first MUX switch M31 may be turned in response to a first MUX signal MS1 and may connect the first data line DL1 to the data line DL11 of the first sub-pixel. The third-first MUX switch M31 includes a gate electrode to which the first MUX signal MS1 is applied, a first electrode connected to the first data line DL1, and a second electrode connected to the data line DL11 of the first sub-pixel.

When the third-first MUX switch M31 is turned on, the first scan signal SCAN1_O may be applied to the first sub-pixel, and the first data voltage according to the first mode may be supplied to the first sub-pixel.

The fourth-first MUX switch M41 may be turned on in response to a second MUX signal MS2 and may connect the first data line DL1 to a data line DL12 of the second sub-pixel. The fourth-first MUX switch M41 includes a gate electrode to which the second MUX signal MS2 is applied, a first electrode connected to the first data line DL1, and a second electrode connected to the data line DL12 of the second sub-pixel. In some embodiments, the phase of the first MUX signal MS1 and the phase of the second MUX signal MS2 are different.

When the fourth-first MUX switch M41 is turned on, the first scan signal SCAN1_E may be applied to the second sub-pixel, and the second data voltage or the ground voltage according to the second mode may be supplied to the second sub-pixel.

The third-second MUX switch M32 may be turned on in response to the first MUX signal MS1 and may connect the second data line DL2 to the data line DL21 of the first sub-pixel. The third-second MUX switch M32 includes a gate electrode to which the first MUX signal MS1 is applied, a first electrode connected to the second data line DL2, and a second electrode connected to the data line DL21 of the first sub-pixel.

When the third-second MUX switch M32 is turned on, the first scan signal SCAN1_O may be applied to the first sub-pixel, and the first data voltage according to the first mode may be supplied to the first sub-pixel.

The fourth-second MUX switch M42 may be turned on in response to t second MUX signal MS2 and may connect the second data line DL2 to the data line DL22 of the second sub-pixel. The fourth-second MUX switch M42 includes a gate electrode to which the second MUX signal MS2 is applied, a first electrode connected to the second data line DL2, and a second electrode connected to the data line DL22 of the second sub-pixel.

When the fourth-second MUX switch M42 is turned on, the first scan signal SCAN1_E may be applied to the second sub-pixel, and the second data voltage or the ground voltage according to the second mode may be supplied to the second sub-pixel.

The third-third MUX switch M33 may be turned on in response to the first MUX signal MS1 and may connect the third data line DL3 to the data line DL31 of the first sub-pixel. The third-third MUX switch M33 includes a gate electrode to which the first MUX signal MS1 is applied, a first electrode connected to the third data line DL3, and a second electrode connected to the data line DL31 of the first sub-pixel.

When the third-third MUX switch M33 is turned on, the first scan signal SCAN1_O may be applied to the first sub-pixel, and the first data voltage according to the first mode may be supplied to the first sub-pixel.

The fourth-third MUX switch M43 may be turned on in response to the second MUX signal MS2 and may connect the third data line DL3 to the data line DL32 of the second sub-pixel. The fourth-third MUX switch M43 includes a gate electrode to which the second MUX signal MS2 is applied, a first electrode connected to the third data line DL3, and a second electrode connected to the data line DL32 of the second sub-pixel.

When the fourth-third MUX switch M43 is turned on, the first scan signal SCAN1_E may be applied to the second sub-pixel, and the second data voltage or the ground voltage according to the second mode may be supplied to the second sub-pixel.

The driving switch ST may supply or block a bias voltage Vbias to the output amplifier AMP. The driving switch ST may be turned on or off in response to a switch control signal SWC. The switch control signal SWC may be provided from a timing controller.

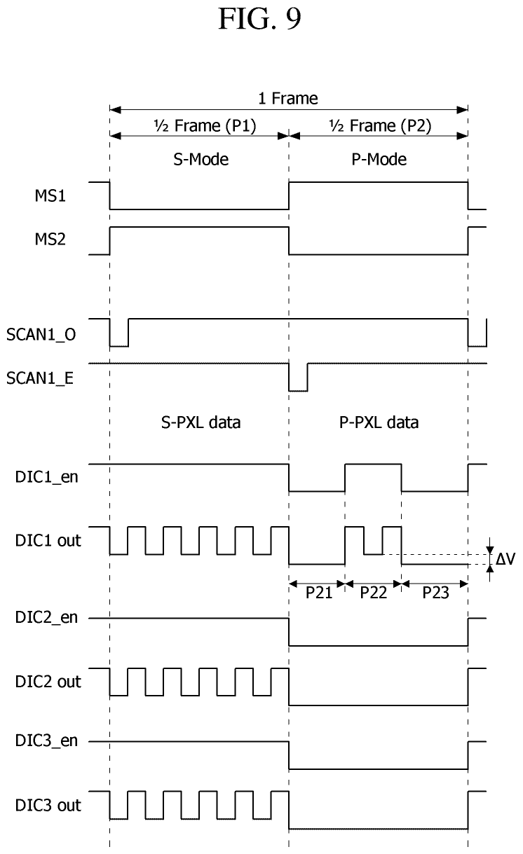

FIGS. 9 to 12 are diagrams illustrating an operation of the mode selector shown in FIG. 8.

Referring to FIGS. 6, 9, and 10, a data voltage S-PXL data according to the first mode may be supplied to the first sub-pixels of the sub-pixel for each color in a first half frame period P1.

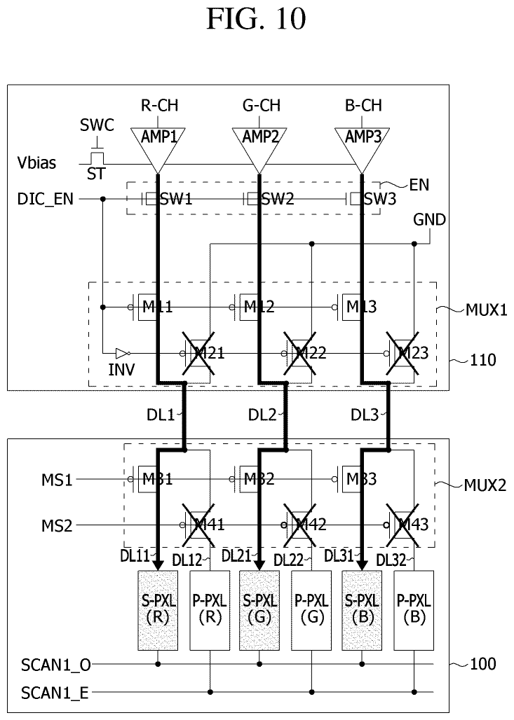

To this end, the first MUX signal MS1 at a gate on voltage, the second MUX signal MS2 at a gate off voltage, a first enable signal DIC1_en at a gate on voltage, a second enable signal DIC2_en at a gate on voltage, and a third enable signal DIC3_en at a gate on voltage may be applied. For this reason, as in FIG. 10 the first to third switches SW1, SW2, and SW3 are turned on, the first-first to first-third MUX switches M11, M12, and M13 and the third-first to third-third MUX switches M31, M32, and M33 are turned on, and the second-first to second-third MUX switches M21, M22, and M23 and the fourth-first to fourth-third MUX switches M41, M42, and M43 are turned off.

The first scan signal SCAN1_O at the gate on voltage may be applied to the first sub-pixel, and the first scan signal SCAN1_E at the gate off voltage may be applied to the second sub-pixel.

Accordingly, in the first half frame period P1, the first data voltage may supplied to the first sub-pixels of the sub-pixel for each color in the first display area AA1, the second display area AA2, and the third display area AA3 of FIG. 6.

Referring to FIGS. 6, 9, 11, and 12, the ground voltage according to the second mode may be supplied to the second sub-pixels of the sub-pixel for each color in a second-first period P21 of a second half frame period P2, a data voltage P-PXL data according to the second mode may be supplied to the second sub-pixels of the sub-pixel for each color in a second-second period P22, and the ground voltage according to the second mode may be supplied to the second sub-pixels of the sub-pixel for each color in a second-third period P23.

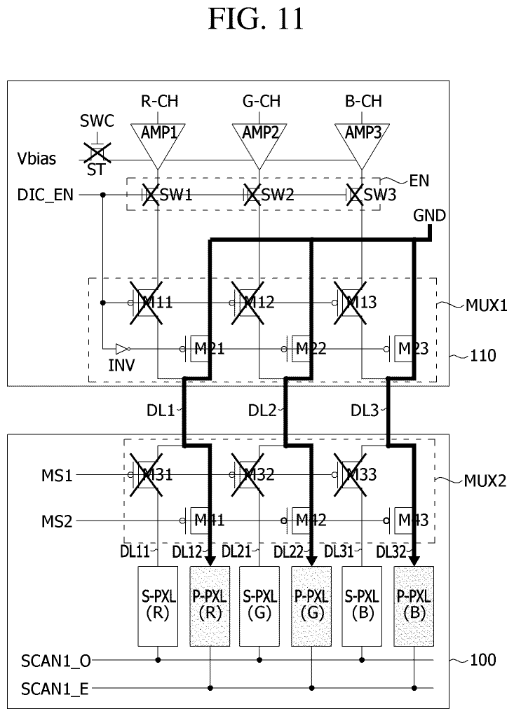

In the second-first period P21 and the second-third period P23, the first MUX signal MS1 at a gate off voltage, the second MUX signal MS2 at a gate on voltage, the first enable signal DIC1_en at a gate off voltage, the second enable signal DIC2_en at a gate off voltage, and the third enable signal DIC3_en at a gate off voltage may be applied. For this reason, as in FIG. 11, the first to third switches SW1, SW2, and SW3 are turned off, the first-first to first-third MUX switches M11, M12, and M13, and the third-first to third-third MUX switches M31, M32, and M33 are turned off, and the second-first to second-third MUX switches M21, M22, and M23 and the fourth-first to fourth-third MUX switches M41, M42, and M43 are turned on.

The first scan signal SCAN1_O at a gate off voltage may be applied to the first sub-pixel, and the first scan signal SCAN1_E at a gate on voltage may be applied to the second sub-pixel.

Accordingly, in the second-first period P21 and the second-third period P23, the ground voltage may be supplied to the second sub-pixels of the sub-pixel for each color in a partial area of the first display area AA1 of FIG. 6. Further, the ground voltage may be supplied to the second sub-pixels of the sub-pixel for each color in the entire second and third display areas AA2 and AA3.

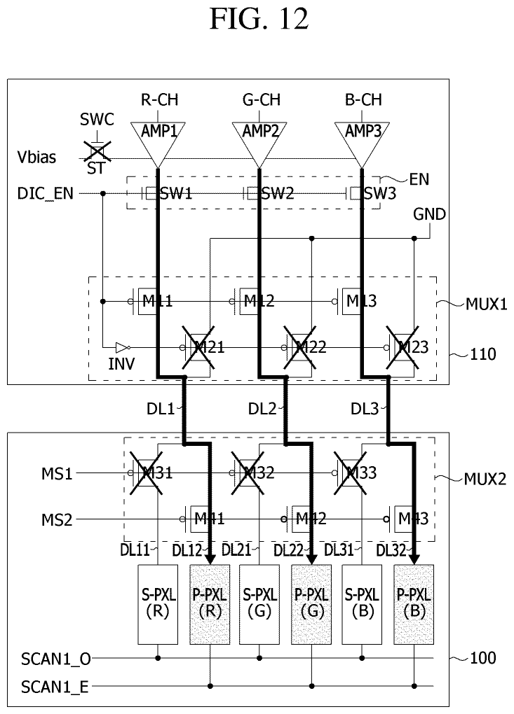

In the second-second period P22, the first MUX signal MS1 at the gate off voltage, the second MUX signal MS2 at the gate on voltage, the first enable signal DIC1_en at the gate on voltage, the second enable signal DIC2_en at the gate on voltage, and the third enable signal DIC3_en at the gate on voltage may be applied. For this reason, as in FIG. 12, the first to third switches SW1, SW2, and SW3 are turned on, the first MUX switches M11, M12, and M13, and the fourth MUX switches M41, M42, and M43 are turned on and the second MUX switches M21, M22, and M23 and the third MUX switches M31, M32, and M33 are turned off.

The first scan signal SCAN1_O at the gate off voltage may be applied the first sub-pixel, and the first scan signal SCAN1_E at the gate on voltage may be applied to the second sub-pixel.

Accordingly, in the second-second period P22, the second data voltage may be supplied to the second sub-pixels of the sub-pixel for each color in the first display area AA1 of FIG. 6. The ground voltage may be supplied to the second sub-pixels of the sub-pixel for each color in the second display area AA2 and the third display area AA3.

A level of the ground voltage may be formed to be lower a level of t data voltage of the lowest grayscale by ΔV. Here, ΔV may be 0.7 V, but is not necessarily limited thereto.

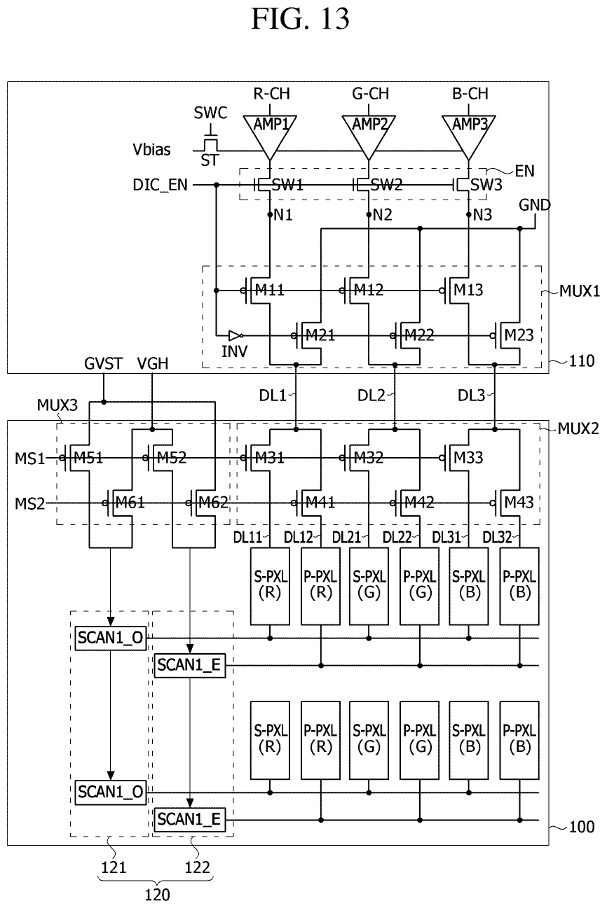

FIG. 13 is a diagram showing a mode selector according to a second embodiment of the present disclosure.

Referring to FIG. 13, a mode selector SEL according to a second embodiment of the present disclosure may include a first switch part EN, a second switch part MUX1, a third switch part MUX2, a fourth switch part MUX3, and a driving switch ST.

The first switch part EN, the second switch part MUX1, and the third switch part MUX2 of the second embodiment have the same configurations and functions as those in the first embodiment shown in FIG. 9, and thus, description thereof will not be repeated.

The fourth switch part MUX3 may output one of a start signal or a gate off voltage to a first scan driver in response to the MUX signal MS1 or MS2. The fourth switch part MUX3 may include a fifth-first MUX switch M51, a sixth-first MUX switch M61, a fifth-second MUX switch M52, and a sixth-second MUX switch M62. Each of the fifth-first MUX switch M51, the sixth-first MUX switch M61, the fifth-second MUX switch M52, and the sixth-second MUX switch M62 may be implemented as a p-channel TFT, but embodiments of the present disclosure are not limited thereto.

The fifth-first MUX switch M51 and the fifth-second MUX switch M52 may be collectively referred to as a fifth MUX switch, and the sixth-first MUX switch M61 and the sixth-second MUX switch M62 may be referred to as a sixth MUX switch.

The fifth-first MUX switch M51 may be turned on in response to the fir MUX signal MS1 and may supply the start signal to the first scan driver 121. The fifth-first MUX switch M51 includes a gate electrode to which the first MUX signal MS1, a first electrode to which a start signal GVST is applied, and a second electrode connected to a first scan driver 121. As shown in FIG. 13, the gate driver 120 includes a first scan driver 121 and a second scan driver 122.

The sixth-first MUX switch M61 may be turned on in response to the second MUX signal MS2 and may supply the gate off voltage to the first scan driver 121. The sixth-first MUX switch M61 includes a gate electrode to which the second MUX signal MS2 is applied, a first electrode to which a gate off voltage VGH is applied, and a second electrode connected to the first scan driver 121.

The fifth-second MUX switch M52 may be turned on in response to the first MUX signal MS1 and may supply the gate off voltage VGH to a second scan driver 122. The fifth-second MUX switch M52 includes a gate electrode to which the first MUX signal MS1 is applied, a first electrode to which the gate off voltage VGH is applied, and a second electrode connected to the second scan driver 122.

The sixth-second MUX switch M62 may be turned on in response to the second MUX signal MS2 and may supply the start signal GVST to the second scan driver 122. The sixth-second MUX switch M62 includes a gate electrode to which the second MUX signal MS2 is applied, a first electrode to which the start signal GVST is applied, and a second electrode connected to the second scan driver 122.

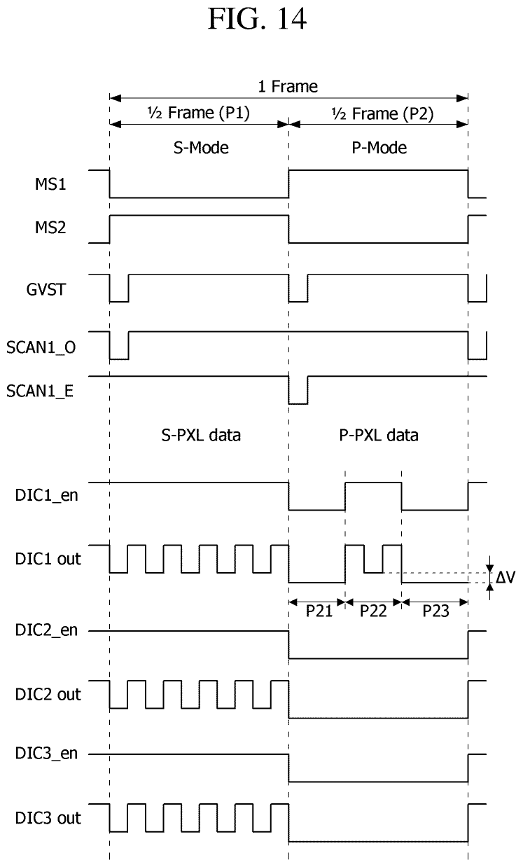

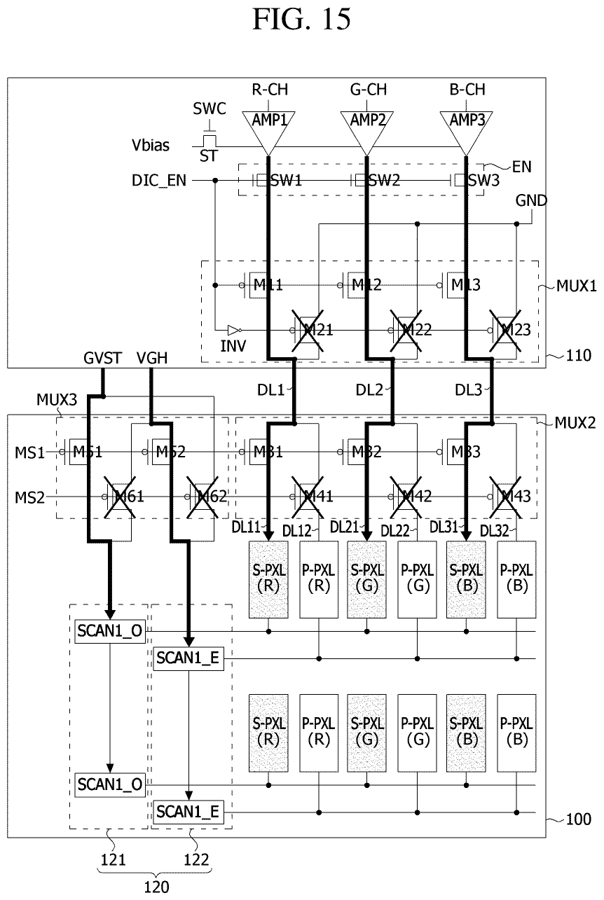

FIGS. 14 to 17 are diagrams illustrating an operation of a MUX switch part shown in FIG. 13.

Referring to FIGS. 6, 14, and 15, in the first half frame period P1, the data voltage S-PXL data according to the first mode may be supplied to the first sub-pixels of the sub-pixel for each color.

To this end, the first MUX signal MS1 at the gate on voltage, the second MUX signal MS2 at the gate off voltage, the first enable signal DIC1_en at the gate on voltage, the second enable signal DIC2_en at the gate on voltage, and the third enable signal DIC3_en at the gate on voltage may be applied. For this reason, as in FIG. 15, the first to third switches SW1, SW2, and SW3, the first-first to first-third MUX switches M11, M12, and M13, the third-first to third-third MUX switches M31, M32, and M33, and the fifth-first and fifth-second MUX switches M51 and M52 are turned on, and the second-first to second-third MUX switches M21, M22, and M23, the fourth-first to fourth-third MUX switches M41, M42, and M43, and the sixth-first and sixth-second MUX switches M61 and M62 are turned off.

The fifth-first and fifth-second MUX switches M51 and M52 are turned on, such that the first scan signal SCAN1_O at the gate on voltage may be applied to the first sub-pixels from the first scan driver 121 to which the start signal is applied. The sixth-first and sixth-second MUX switches M61 and M62 are turned off, such that the first scan signal SCAN1_E at the gate off voltage may be applied to the second sub-pixels from the first scan driver 122 to which the gate off voltage is applied.

Accordingly, in the first half frame period P1, the first data voltage may supplied to the first sub-pixels of the sub-pixel for each color in the first display area, the second display area, and the third display area of FIG. 6.

Referring to FIGS. 6, 14, 16, and 17, the ground voltage according to t second mode may be applied to the second sub-pixels of the sub-pixel for each color in the second-first period P21 of the second half frame period P2, the data voltage P-PXL data according to the second mode may be applied to the second sub-pixels of the sub-pixel for each color in the second-second period P22, and the ground voltage according to the second mode may be supplied to the second sub-pixels of the sub-pixel for each color in the second-third period P23.

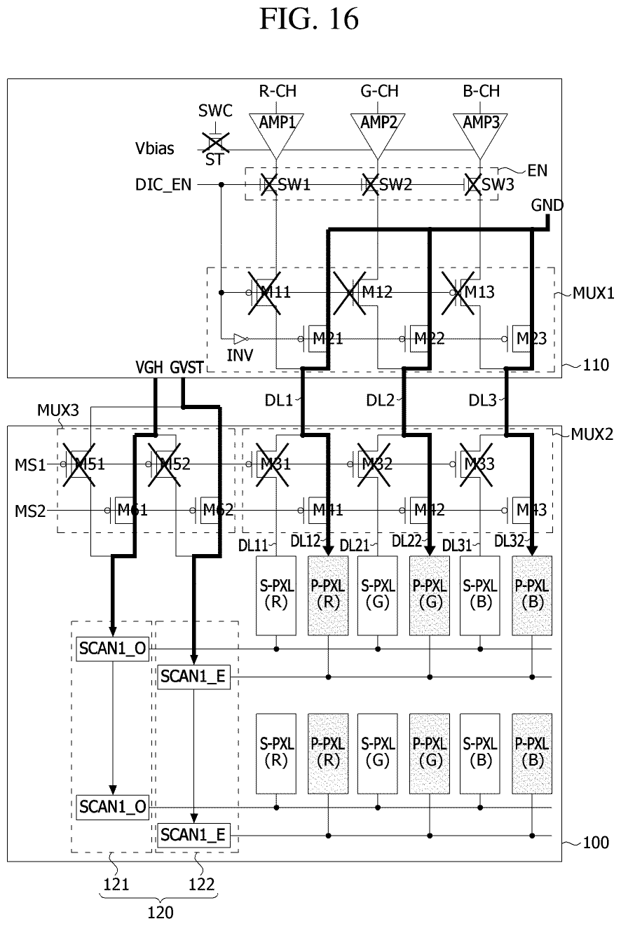

In the second-first period P21 and the second-third period P23, the first MUX signal MS1 at the gate off voltage, the second MUX signal MS2 at the gate on voltage, the first enable signal DIC1_en at the gate off voltage, the second enable signal DIC2_en at the gate off voltage, and the third enable signal DIC3_en at the gate off voltage may be applied. For this reason, as in FIG. 16, the first to third switches SW1, SW2, and SW3 are turned off, the second-first to second-third MUX switches M21, M22, and M23, the fourth-first to fourth-third MUX switches M41, M42, and M43, and the sixth-first and sixth-second MUX switches M61 and M62 are turned on, and the first-first to first-third MUX switches M11, M12, and M13, the third-first to third-third MUX switches M31, M32, and M33, and the fifth-first and fifth-second MUX switches M51 and M52 are turned off.

The fifth-first MUX switch M51 is turned off and the sixth-first MUX switch M61 is turned on, such that the first scan signal SCAN1_O at the gate off voltage may be applied to the first sub-pixels from the first scan driver 121 to which the gate off voltage VGH is applied. The fifth-second MUX switch M52 is turned off and the sixth-second MUX switch M62 is turned on, such that the first scan signal SCAN1_E at the gate on voltage may be applied to the second sub-pixels from the second scan driver 122 to which the start signal GVST is applied.

Accordingly, in the second-first period P21 and the second-third period P23, the ground voltage may be supplied to the second sub-pixels of the sub-pixel for each color in a partial area of the first display area of FIG. 6. Further, the ground voltage may be supplied to the second sub-pixels of the sub-pixel for each color in the entire second and third display areas.

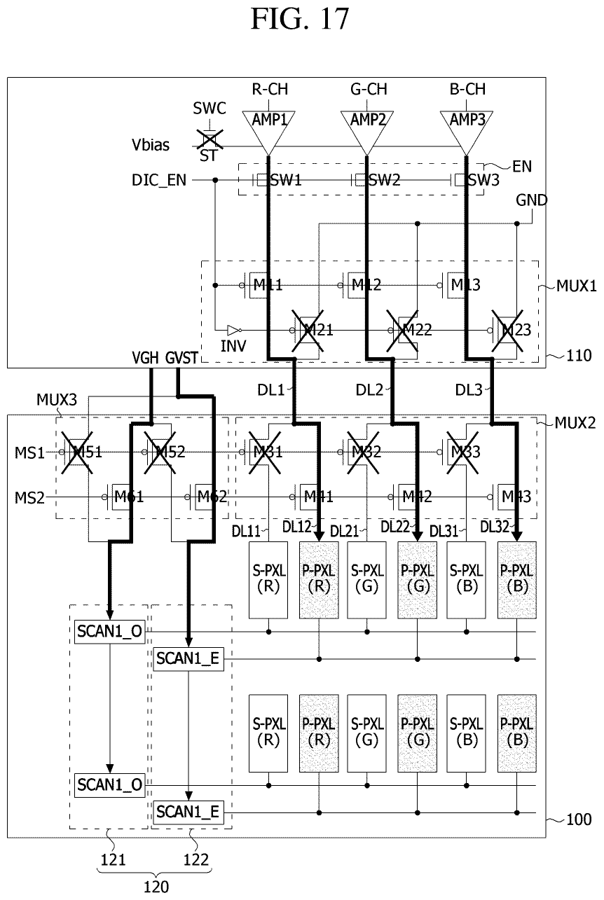

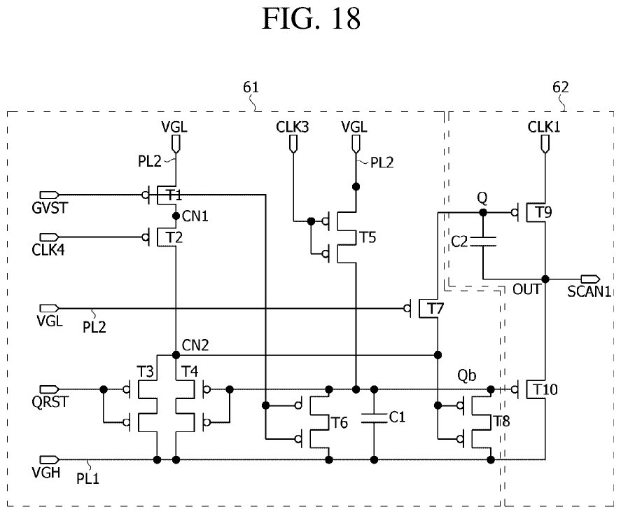

In the second-second period P22, the first MUX signal MS1 at the gate off voltage, the second MUX signal MS2 at the gate on voltage, the first enable signal DIC1_en at the gate on voltage, the second enable signal DIC2_en at the gate off voltage, and the third enable signal DIC3_en at the gate off voltage may be applied. For this reason, as in FIG. 17, the first to third switches SW1, SW2, and SW3, the first-first to first-third MUX switches M11, M12, and M13, the fourth-first to fourth-third MUX switches M41, M42, and M43, and the sixth-first and sixth-second MUX switches M61 and M62 are turned on, and the second-first to second-third MUX switches M21, M22, and M23, the third-first to third-third MUX switches M31, M32, and M33, and the fifth-first and fifth-second MUX switches M51 and M52 are turned off.

The fifth-first MUX switch M51 is turned off and the sixth-first MUX switch M61 is turned on, such that the first scan signal SCAN1_O at the gate off voltage may be applied to the first sub-pixels from the first scan driver 121 to which the gate off voltage VGH is applied. The fifth-second MUX switch M52 is turned off and the sixth-second MUX switch M62 is turned on, such that the first scan signal SCAN1_E at the gate on voltage may be applied to the second sub-pixels from the first scan driver 122 to which the start signal GVST is applied.

Accordingly, in the second half frame period, the second data voltage may be supplied to the second sub-pixels of the sub-pixel for each color in the first display area of FIG. 6. Further, the ground voltage may be supplied to the second sub-pixels of the sub-pixel for each color in the second display area and the third display area.

FIG. 18 is a diagram showing an implementation example of a first scan driver shown in FIG. 13.

Referring to FIG. 18, the first scan driver according to the embodiment the present disclosure may include a first control node (hereinafter, referred to as a “Q node”) where an output voltage is pulled up, a second control node (hereinafter, referred to as a “Qb node”) where an output voltage is pulled down, a control circuit 61, and an output circuit 62.

The control circuit 61 serves to control charging and discharging of the first control node Q and the second control node Qb. The control circuit 61 includes a first transistor T1, a second transistor T2, a third transistor T3, a fourth transistor T4, a fifth transistor T5, a sixth transistor T6, a seventh transistor T7, an eighth transistor T8, and a first capacitor C1.

The first transistor T1 is turned on in response to the start signal GVST and connects, to a first connection node CN1, the second power line PL2 to which a low-potential voltage is applied. The first transistor T1 includes a gate electrode to which the start signal GVST is applied, a first electrode connected to the second power line PL2, and a second electrode connected to the first connection node CN1.

The second transistor T2 is turned on in response to a clock signal CLK4 and connects the first connection node CN1 and a second connection node CN2. The second transistor T2 includes a gate electrode to which the clock signal CLK4 is applied, a first electrode connected to the first connection node CN1, and a second electrode connected to the second connection node CN2.

The third transistor T3 is turned on in response to a reset signal QRST and connects, to the second connection node CN2, the first power line PL1 to which a high-potential voltage VGH is applied. The third transistor T3 includes a gate electrode to which the reset signal QRST is applied, a first electrode connected to the second connection node CN2, and a second electrode connected to the first power line PL1.

The fourth transistor T4 is turned on according to the second control node Qb and connects the first power line PL1 to the second connection node CN2. The fourth transistor T4 includes a gate electrode connected to the second control node Qb, a first electrode connected to the second connection node CN2, and a second electrode connected to the first power line PL1.

The fifth transistor T5 is turned on in response to a clock signal CLK3 and connects the second power line PL2 to the second control node Qb. The fifth transistor T5 includes a gate electrode to which the clock signal CLK3 is applied, a first electrode connected to the second power line PL2, and a second electrode connected to the second control node Qb.

The sixth transistor T6 is turned on in response to the start signal GVST and connects the first power line PL1 to the second control node Qb. The sixth transistor T6 includes a gate electrode to which the start signal GVST is applied, a first electrode connected to the second control node Qb, and a second electrode connected to the first power line PL1.

The seventh transistor T7 is turned on in response to the low-potential voltage and connects the second connection node CN2 and the first control node Q. The seventh transistor T7 includes a gate electrode connected to the second power line PL2, a first electrode connected to the second connection node CN2, and a second electrode connected to the first control node Q.

The eighth transistor T8 is turned on in response to a voltage of the second connection node CN2 and connects the first power line PL1 to the second control node Qb. The eighth transistor T8 includes a gate electrode connected to the second connection node CN2, a first electrode connected to the second control node Qb, and a second electrode connected to the first power line PL1.

The first capacitor C1 is connected between the second control node Qb and the first power line PL1.

The third transistor T3, the fourth transistor T4, the fifth transistor T5, the sixth transistor T6, and the eighth transistor T8 may have a dual gate structure to minimize current leakage.

The output circuit 62 may output the first scan signal SCAN1 from an output node OUT on the basis of potentials of the first control node Q and the second control node Qb. The output circuit 62 includes a ninth transistor T9, a tenth transistor T10, and a second capacitor C2.

The ninth transistor T9 is turned on in response to a voltage of the first control node Q and outputs a clock signal CLK1 to the output node OUT. The ninth transistor T9 includes a gate electrode connected to the first control node Q, a first electrode to which the clock signal CLK1 is applied, and a second electrode connected to the output node OUT.

The tenth transistor T10 is turned on in response to a voltage of the second control node Qb and outputs the first power line PL1 to the output node OUT. The tenth transistor T10 includes a gate electrode connected to the second control node Qb, a first electrode connected to the output node OUT, and a second electrode connected to the first power line PL1.

The second capacitor C2 is connected between the gate electrode and the second electrode of the ninth transistor T9.

In the embodiment, when the start signal GVST at a low level voltage is applied, the first scan signal SCAN1 at a gate on voltage may be output, and when the high-potential voltage VGH that is a high level voltage is applied, the first scan signal SCAN1 at a gate off voltage may be output.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A display device comprising:
a display panel in which a plurality of data lines, a plurality of gate lines, and a plurality of sub-pixels are disposed;
a data driver including an output amplifier configured to supply a data voltage of pixel data to the data lines; and
a gate driver configured to supply a gate signal to the gate lines,
wherein:
each of the plurality of sub-pixels includes a first sub-pixel including a first light-emitting element that emits light at a first viewing angle in a first mode and a first driving element that drives the first light-emitting element, and a second sub-pixel including a second light-emitting element that emits light at a second viewing angle smaller than the first viewing angle in a second mode and a second driving element that drives the second light-emitting element, and
the first light-emitting element emits light in a first half frame period of one frame period, and the second light-emitting element emits light in a second half frame period of the one frame period.

2. The display device according to claim 1, further comprising:
a mode selector configured to selectively supply the data voltage output from the output amplifier to the first sub-pixel or the second sub-pixel.

3. The display device according to claim 2,
wherein the mode selector includes:
a first switch part connected to an output end of the output amplifier and configured to transmit or block the data voltage output from the output end in response to an enable signal;
a second switch part configured to selectively output the transmitted data voltage or a ground voltage in response to the enable signal, wherein the ground voltage is predetermined; and
a third switch part configured to supply the selectively output data voltage or the ground voltage to the first sub-pixel or the second sub-pixel in response to a MUX signal.

4. The display device according to claim 3, wherein the ground voltage is a voltage lower than a data voltage of a lowest grayscale.

5. The display device according to claim 3, wherein:
the first switch part includes multiple switches, and
each of the multiple switches includes a gate electrode to which the enable signal is applied, a first electrode connected to the output end of the output amplifier, and a second electrode connected to a channel node.

6. The display device according to claim 3, wherein the second switch part includes:
a first MUX switch configured to output the transmitted data voltage in response to the enable signal;
an inverter configured to invert a phase of the enable signal; and
a second MUX switch configured to output the ground voltage in response to the phase-inverted enable signal.

7. The display device according to claim 6, wherein:
the first MUX switch includes a gate electrode to which the enable signal is applied, a first electrode to which the data voltage is transmitted, and a second electrode connected to the data line, and
the second MUX switch includes a gate electrode to which the phase-inverted enable signal is applied, a first electrode to which the ground voltage is applied, and a second electrode connected to the data line.

8. The display device according to claim 3, wherein the MUX signal includes a first MUX signal and a second MUX signal having a phase different from the first MUX signal, and
wherein the third switch part includes:
a third MUX switch configured to supply the transmitted data voltage to the first sub-pixel in response to the first MUX signal; and
a fourth MUX switch configured to supply the transmitted data voltage or the ground voltage to the second sub-pixel in response to the second MUX signal.

9. The display device according to claim 8, wherein:
the third MUX switch includes a gate electrode to which the first MUX signal is applied, a first electrode connected to the data line, and a second electrode connected to a data line of the first sub-pixel, and
the fourth MUX switch includes a gate electrode to which the second MUX signal is applied, a first electrode connected to the data line, and a second electrode connected to a data line of the second sub-pixel.

10. The display device according to claim 3, further comprising:
a fourth switch part configured to selectively supply a gate on voltage or a gate off voltage as a start signal to the gate driver in response to the MUX signal.

11. The display device according to claim 10, wherein the MUX signal includes a first MUX signal and a second MUX signal having a phase different from the first MUX signal, and
wherein the fourth switch part includes:
a fifth-first MUX switch configured to supply the start signal at the gate on voltage to the gate driver connected to the first sub-pixel in response to the first MUX signal;
a fifth-second MUX switch configured to supply the start signal at the gate off voltage to the gate driver connected to the first sub-pixel in response to the second MUX signal;
a sixth-first MUX switch configured to supply the start signal at the gate off voltage to the gate driver connected to the second sub-pixel in response to the first MUX signal; and
a sixth-second MUX switch configured to supply the start signal at the gate on voltage to the gate driver connected to the second sub-pixel in response to the second MUX signal.

12. The display device according to claim 3, wherein the mode selector further includes:
a driving switch configured to block a bias voltage that is applied to the output amplifier when the data voltage is blocked by the first switch part.

13. The display device according to claim 3, wherein the third switch part is configured to supply the data voltage to the first sub-pixel in the first mode and supply the data voltage or the ground voltage to the second sub-pixel in the second mode.

14. A mode selection circuit comprising:
a first switch part connected to an output end of an output amplifier in a data driver, and configured to transmit or block a data voltage that is output from the output end, in response to an enable signal;
a second switch part configured to selectively output the transmitted data voltage or a predetermined ground voltage in response to the enable signal; and
a third switch part configured to supply the output data voltage or ground voltage to each of a plurality of sub-pixels in response to a MUX signal,
wherein:
each of the plurality of sub-pixels includes a first sub-pixel including a first light-emitting element that emits light at a first viewing angle in a first mode and a first driving element that drives the first light-emitting element and a second sub-pixel including a second light-emitting element that emits light at a second viewing angle smaller than the first viewing angle in a second mode and a second driving element that drives the second light-emitting element, and
the first light-emitting element emits light in a first half frame period of one frame period, and the second light-emitting element emits light in a second half frame period of the one frame period.

15. The mode selection circuit according to claim 14, wherein:
the first switch part includes multiple switches, and
each of the multiple switches includes a gate electrode to which the enable signal is applied, a first electrode connected to the output end of the output amplifier, and a second electrode connected to a channel node.

16. The mode selection circuit according to claim 14, wherein the second switch part includes:
a first MUX switch configured to output the transmitted data voltage in response to the enable signal;
an inverter configured to invert a phase of the enable signal; and
a second MUX switch configured to output the ground voltage in response to the phase-inverted enable signal.

17. The mode selection circuit according to claim 14, wherein the MUX signal includes a first MUX signal and a second MUX signal having a phase different from the first MUX signal, and
wherein the third switch part includes:
a third MUX switch configured to supply the transmitted data voltage to the first sub-pixel in response to the first MUX signal; and
a fourth MUX switch configured to supply the transmitted data voltage or the ground voltage to the second sub-pixel in response to the second MUX signal.

18. The mode selection circuit according to claim 17, further comprising:
a fourth switch part configured to selectively supply a gate on voltage or a gate off voltage as a start signal to a gate driver in response to the MUX signal,
wherein the fourth switch part includes:
a fifth-first MUX switch configured to supply the start signal at the gate on voltage to the gate driver connected to the first sub-pixel in response to the first MUX signal;
a fifth-second MUX switch configured to supply the start signal at the gate off voltage to the gate driver connected to the first sub-pixel in response to the second MUX signal;
a sixth-first MUX switch configured to supply the start signal at the gate off voltage to the gate driver connected to the second sub-pixel in response to the first MUX signal; and
a sixth-second MUX switch configured to supply the start signal at the gate on voltage to the gate driver connected to the second sub-pixel in response to the second MUX signal.

19. The mode selection circuit according to claim 14, further comprising:
a driving switch configured to block a bias voltage that is applied to the output amplifier when the data voltage is blocked by the first switch part.
